(19) United States
(12) Patent Application Publication
(10) Pub. No.: US 2019/0025807 A1
(43) Pub. Date: Jan. 24, 2019

(54) DEVICE INFORMATION PROVIDING APPARATUS, DEVICE INFORMATION PROVIDING METHOD, AND STORAGE MEDIUM

(71) Applicant: YOKOGAWA ELECTRIC CORPORATION, Tokyo (JP)

(72) Inventors: Keiichiro Kobuchi, Tokyo (JP); Soichiro Konada, Tokyo (JP); Norio Tanaka, Tokyo (JP)

(73) Assignee: YOKOGAWA ELECTRIC CORPORATION, Tokyo (JP)

(21) Appl. No.: 16/032,866

(22) Filed: Jul. 11, 2018

(30) Foreign Application Priority Data
Jul. 18, 2017 (JP) 2017-139273

(51) Int. Cl. G05B 23/02; G05B 19/418

(52) U.S. Cl. CPC G05B 23/0235; G05B 23/027; G05B 19/418; G05B 23/021; G05B 23/0245

(57) ABSTRACT

A device information providing apparatus includes: a central processing unit (CPU) that: transmits an acquisition request for acquiring a first data to a device installed in a plant; and provides, to a control apparatus for controlling the plant, second data output from the device, wherein the second data is acquired by performing a predetermined process for the first data detected by the device; and a storage that stores the first data output from the device based on the acquisition request. The CPU further provides the first data stored in the storage to outside of the device information providing apparatus based on a use request input from the outside.

### TECHNICAL FIELD

The present invention relates to a device information providing apparatus, a device information providing method, and a storage medium.

The present application claims priority based on Japanese patent application 2017-139273, filed on Jul. 18, 2017 and includes herein by reference the content thereof.

### BACKGROUND ART

In plants such as chemical industry plants and the like, a plant that manages and controls a well site of a gas field, an oil field, or the like and the surroundings thereof, a plant that manages and controls power generation such as hydroelectric power generation, thermal power generation, nuclear power generation, or the like, a plant that manages and controls environmental power generation such as solar power generation and wind power generation, or the like, or a plant that manages and controls water supply and sewerage, a dam, or the like and factories (hereinafter, in a case in which these are collectively referred to, they will be referred to as “plants”), distributed control systems (DCSs), supervisory control and data acquisition (SCADA) systems, and the like have been built in which field instruments such as measuring devices (sensor devices), actuators (actuator devices), and the like called field devices and a control apparatus controlling these are connected through a communication unit are built, and a high-degree automatic operation is realized.

In such a plant, a control apparatus (controller), for example, controls the operation of the actuator by acquiring measurement data, which is acquired by measuring a pressure, a temperature, a flow rate, a water level, or the like relating to a fluid body such as a gas or a liquid handled inside the plant using a sensor such as a differential pressure/pressure transmitter, a temperature transmitter, a flowmeter, or a level meter, at a predetermined timing (period) and transmitting control data such as drive data to an actuator such as a valve or a pump at a predetermined timing on the basis of an acquired measurement value. Hereinafter, information used for control that is transmitted and received between a field device in the related art and controller will be referred to as “control data.” For example, control data is transmitted and received between a field device and a controller at a period of one second.

A controller of a plant stores all or a selected portion of the control data in a data server used for storing data. The control data stored in the data server, for example, is read by an operation monitoring apparatus monitored by an operator who operates the plant or a device monitoring apparatus monitored by a device maintenance staff who performs maintenance of devices. The operator changes an operation condition, for example, by changing setting values set in a field device or the like on the basis of the read control data. The device maintenance staff performs a maintenance operation such as calibration, adjustment, or replacement of the field device on the basis of the read control data.

According to recent technology trends, sensors can measure physical phenomena more accurately at higher speeds. Such physical phenomena cause noise in accordance with the states of pumps, valves, and pipes installed in a plant to be input to a sensor. There is a possibility of such noise disturbing controllability, and accordingly, there are cases in which a filtering process is performed to decrease errors in measurement data in a sensor or a control system. In order to perform control, refraining from adding a noise level that is better ignored in control calculation is one method of stably controlling a plant.

In a plant, there is a technology for detecting various types of abnormalities such as an abnormality in a fluid such as cavitation or a pulsating flow generated in a fluid body, occurrence of slurry noise according to mixture of a foreign material, or pipe clogging on the basis of measurement data measured by a sensor (for example, refer to Japanese Unexamined Patent Application, First Publication No. H11-287704). In detecting an abnormality in a process, it is necessary to install sensors for abnormality detection at detection places. However, since many sensors for process control are installed in a plant, in a case in which the sensors for process control can be used for abnormality detection, the cost can be lower than that of a case in which sensors for abnormality detection are separately installed. In order to use sensors used for process control for abnormality detection, for example, measurement data acquired by a process control system is accumulated in a data server over a long period, the accumulated measurement data is analyzed in accordance with a type of abnormality to be detected, and an abnormality signal representing an abnormality included in the measurement data is detected. By increasing the number of pieces of measurement data to be analyzed, the accuracy of detection of an abnormality signal can be improved.

There are cases in which the signal level of an abnormality signal caused by an abnormality of a plant is low. There are cases in which the characteristics of an abnormality signal and the characteristics of a noise are similar to each other. Thus, in a case in which only data for process control, for which a process of eliminating a noise component has been performed, is acquired, there are cases in which an abnormality signal included in measurement data is eliminated together with noise, or the signal level of the abnormality signal is lowered. In a case in which the signal level of an abnormality signal is lowered, in order to improve the accuracy of detection of the abnormality signal, there are cases in which it is necessary to increase the number of pieces of measurement data required for the analysis.

A method of analyzing measurement data is different in accordance with the purpose of use. For example, in measurement data for the purpose of detection of an abnormality signal and measurement data for the purpose of an operation, the acquisition frequency (period) of the measurement data required for the analysis and the accuracy required for the measurement data are different. Depending on the purpose of use, there are cases in which analysis of an actuator is necessary in addition to measurement data. Thus, in a case in which only control data that is periodically acquired and stored by a controller is acquired, there are cases in which data matching the purpose of use cannot be acquired.

### SUMMARY

One or more embodiments of the present invention provide a device information providing apparatus, a device information providing method, and a storage medium capable of providing device data of field devices used as device information according to the purpose of use.

A device information providing apparatus according to one or more embodiments of the present invention may include a first provider configured to provide, to a control apparatus for controlling a plant, second data output from a device installed in the plant, the second data being acquired by performing a predetermined process for first data detected by the device, an acquisition requester configured to transmit an acquisition request for acquiring the first data to the device, a storage storing the first data output from the device based on the acquisition request, and a second provider configured to provide the first data stored in the storage to the outside of the device information providing apparatus based on a use request input from the outside.

In the above-described embodiments of the device information providing apparatus, the acquisition requester may be configured to transmit to the device the acquisition request at a timing of a predetermined period that is necessary for generating the second data inside the device.

In the above-described embodiments of the device information providing apparatus, the acquisition requester may be configured to transmit the acquisition request at a timing asynchronously with a predetermined period that is necessary for generating the second data inside the device.

In the above-described embodiments of the device information providing apparatus, the storage may further store the second data. The second provider may be configured to provide at least one of the first data and the second data stored in the storage based on the use request.

In the above-described embodiments of the device information providing apparatus, the second provider may be configured to receive the use request based on an application programming interface (API) for using data stored in the storage.

In the above-described embodiments of the device information providing apparatus, the first provider may be configured to provide the second data to the control apparatus at a constant period.

In the above-described embodiments of the device information providing apparatus, the first provider may be configured to further provide the second data to the control apparatus asynchronously with the constant period.

The above-described embodiments of the device information providing apparatus may further include a data acquirer configured to acquire the second data periodically transmitted from the device. The acquisition requester may be configured to transmit the acquisition request to the device at a timing different from that of the acquisition of the second data.

In the above-described embodiments of the device information providing apparatus, the acquisition requester may be configured to transmit to the device the acquisition request for acquiring another second data of a different type from that of the second data acquired by the data acquirer at the timing different from that of the acquisition of the second data by the data acquirer.

A device information providing apparatus according to one or more embodiments of the present invention may include a first provider configured to provide control data output from a control apparatus for controlling a plant to a device disposed in the plant, a device data acquisition requester configured to transmit an acquisition request for acquiring first data to the device that acquires second data by performing a predetermined process for the first data detected by the device, a storage storing the first data output from the device based on the acquisition request, and a second provider configured to provide the first data stored in the storage to the outside of the device information providing apparatus based on a use request input from the outside.

A device information providing method according to one or more embodiments of the present invention may include providing, to a control apparatus for controlling a plant, second data output from a device installed in the plant, the second data being acquired by performing a predetermined process for first data detected by the device, transmitting an acquisition request for acquiring the first data to the device, storing the first data output from the device based on the acquisition request, and providing the first data stored to the outside based on a use request input from the outside.

In the above-described embodiments of the device information providing method, the acquisition request may be transmitted to the device at a timing of a predetermined period that is necessary for generating the second data inside the device.

In the above-described embodiments of the device information providing method, the acquisition request may be transmitted to the device at a timing asynchronously with a predetermined period that is necessary for generating the second data inside the device.

The above-described embodiments of the device information providing method may further include storing the second data, and providing at least one of the first data and the second data stored based on the use request.

The above-described embodiments of the device information providing method may further include receiving the use request based on an application programming interface (API) for using data stored.

In the above-described embodiments of the device information providing method, the second data may be provided to the control apparatus at a constant period.

The above-described embodiments of the device information providing method may further include providing the second data to the control apparatus asynchronously with the constant period.

The above-described embodiments of the device information providing method may further include acquiring the second data periodically transmitted from the device. The acquisition request may be transmit to the device at a timing different from that of the acquisition of the second data.

The above-described embodiments of the device information providing method may further include transmitting to the device the acquisition request for acquiring another second data of a different type from that of the second data periodically acquired at the timing different from that of the periodical acquisition of the second data.

A non-transitory computer-readable storage medium according to one or more embodiments of the present invention may store a device information providing program, which when executed by a computer, causes the computer to provide, to a control apparatus for controlling a plant, second data output from a device installed in the plant, the second data being acquired by performing a predetermined process for first data detected by the device, transmit an acquisition request for acquiring the first data to the device, store the first data output from the device based on the acquisition request, and provide the first data stored to the outside based on a use request input from the outside.

According to the one or more embodiments of the present invention, a device information providing apparatus, a device information providing method, and a storage medium capable of providing device data of field devices used as device information according to the purpose of use can be provided.

### BRIEF DESCRIPTION OF DRAWINGS

FIG. 1 is a diagram showing one example configuration of a device information providing apparatus according to one or more embodiments.

FIG. 2 is a diagram showing one example of the hardware configuration of the device information providing apparatus according to one or more embodiments.

FIG. 3 is a diagram showing one example of data transmission and reception between the device information providing apparatus according to one or more embodiments and a sensor device.

FIG. 4 is a diagram showing one example of data transmission and reception between the device information providing apparatus according to one or more embodiments and an actuator device.

FIG. 5 is a diagram showing one example of data transmission and reception between the device information providing apparatus according to one or more embodiments and a utilization device.

FIG. 6 is a flowchart showing one example of a second data acquiring operation of the device information providing apparatus according to one or more embodiments.

FIG. 7 is a flowchart showing one example of a first data acquiring operation of the device information providing apparatus according to one or more embodiments.

FIG. 8 is a flowchart showing one example of a device information providing operation of the device information providing apparatus according to one or more embodiments.

FIG. 9 is a diagram showing a first mounting form of the device information providing apparatus according to one or more embodiments.

FIG. 10 is a diagram showing a second mounting form of the device information providing apparatus according to one or more embodiments.

FIG. 11 is a diagram showing a third mounting form of the device information providing apparatus according to one or more embodiments. FIG. 12 is a diagram showing a fourth mounting form of the device information providing apparatus according to one or more embodiments.

FIG. 13 is a diagram showing a fifth mounting form of the device information providing apparatus according to one or more embodiments.

FIG. 14 is a diagram showing a sixth mounting form of the device information providing apparatus according to one or more embodiments.

FIG. 15 is a diagram showing a seventh mounting form of the device information providing apparatus according to one or more embodiments.

### DETAILED DESCRIPTION

Hereinafter, a device information providing apparatus, a device information providing method, and a storage medium according to one or more embodiments of the present invention will be described in detail with reference to the drawings.

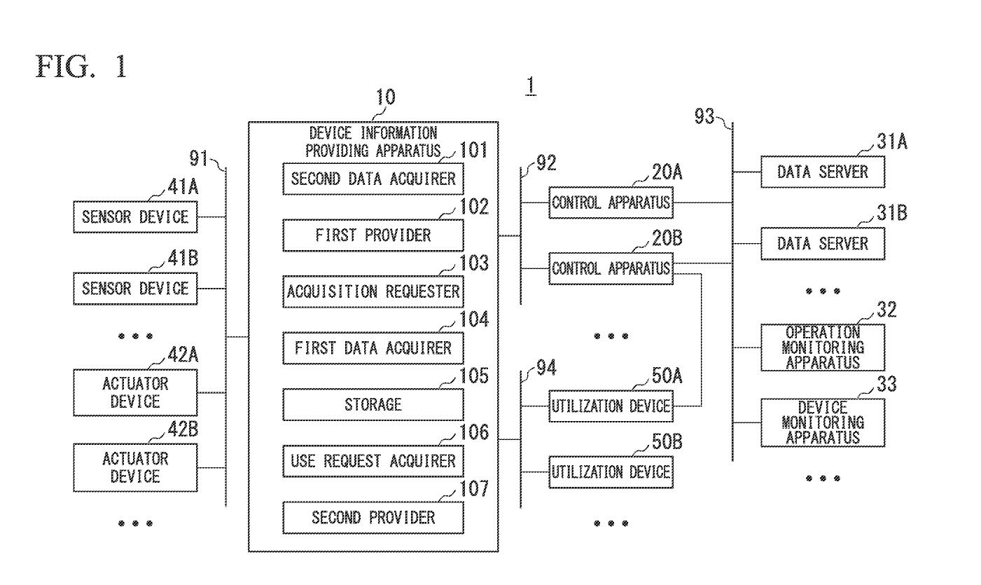

The functions of a device information providing apparatus will be described with reference to FIG. 1. FIG. 1 is a diagram showing one example configuration of a device information providing apparatus 10 according to the one or more embodiments.

As shown in FIG. 1, a device information providing system 1 includes the device information providing apparatus 10, control apparatuses 20 (20A, 20B, and the like), data servers 31 (31A, 31B, and the like), an operation monitoring apparatus 32, a device monitoring apparatus 33, sensor devices 41 (41A, 41B, and the like), actuator devices 42 (42A, 42B, and the like), and utilization devices 50 (50A, 50B, and the like). An example in which the device information providing system 1 is a distributed control system in a plant will be described.

The sensor device 41 is a device that measures a physical quantity such as a pressure, a temperature, a flow rate, a water level, or the like of a fluid such as a gas or a liquid handled inside a plant and is a field device including a measurer (sensor) that converts a physical quantity that is measured (the words “detected” and “measured” may also be used) into an electric signal. The sensor device 41, for example, is a differential pressure/pressure transmitter, a temperature transmitter, a flowmeter, a level meter, or the like. The sensor device 41 generates and outputs calculation data acquired by performing a calculation process, for example, a filtering process of eliminating noise or the like for the measurement data measured by the measurer. The sensor device 41 can transmit calculation data to the device information providing apparatus 10. In the plant, there are cases in which a plurality of sensor devices 41 such as sensor devices 41A, 41B, and the like are installed. The actuator device 42 is a field device including an actuator such as a pump or a valve controlling the flow rate or the like of a fluid body handled inside the plant.

Field devices such as the sensor device 41 and the actuator device 42 are communicably connected to the device information providing apparatus 10 through a network 91 using field communication. The field communication, for example, is based on a communication standard such as ISA100, HART (registered trademark), BRAIN (registered trademark), FOUNDATION Fieldbus, or PROFIBUS. The network 91 may use radio communication in addition to wired communication. The field devices, for example, may be radio field devices in compliance with an ISA100 Wireless standard such as ISA100.11a.

The device information providing apparatus 10 has functions of a second data acquirer 101, a first provider 102, an acquisition requester 103, a first data acquirer 104, a storage 105, a use request acquirer 106, and a second provider 107.

In one or more embodiments, each of the functions of the device information providing apparatus 10 may be realized by a device information providing program (software) controlling the device information providing apparatus 10.

The second data acquirer 101 acquires second data acquired by performing a predetermined process for first data that is device data output from a device installed in a plant and is detected inside the device. In one or more embodiments, as a device (field device) installed in a plant, the sensor device 41 will be described as an example. The “first data” detected in a device is row data (data before processing) detected inside a field device. The first data, for example, is measurement data detected by the sensor device 41, a driving current value of a driver that is detected by the actuator device 42, auxiliary sensor data detected by an auxiliary sensor to be described later, and the like. Such first data is mainly used for a calculation process and the like inside a field device and is not regularly used outside the field device. The “second data” is acquired by performing a predetermined process for the first data. The predetermined process, for example, is a calculation process for the first data that is executed by a calculator or a diagnoser, which will be described later, disposed inside a field device. For example, the second data acquired by performing a calculation process for the measurement data that is the first data is input to the control apparatus 20 at a constant period and is used for process control. The second data may be asynchronously provided for the period described above. The second data may include, for example, diagnosis data acquired by performing a diagnosis process on the basis of auxiliary sensor data that is the first data, a system alarm, and the like that are provided for the device monitoring apparatus 33 and the like.

The second data is acquired by performing a calculation process (processing process) such as a filtering process using the sensor device 41, and by eliminating noise in a case in which the second data is used for controlling the plant, the control process can be stabilized. As described above, there are cases in which the signal level of an analysis target that is not directly used for process control is decreased together with the elimination of noise, and there are cases in which the second data after the processing process cannot be used or is inappropriate for analysis of the plant.

In one or more embodiments, “acquisition” represents acquisition of data or the like in the reception side from the transmission side, and, for example, it may be either data transmission of a push type in which the transmission side as a subject transmits the data to the reception side or data reception of a pull type in which the reception side pulls the data from the transmission side. Thus, the second data acquirer 101 may receive second data that is spontaneously transmitted by the sensor device 41, may request the sensor device 41 to transmit second data and receive the second data, or may download second data from a storage of the sensor device 41.

The first provider 102 provides the second data acquired by the second data acquirer 101 for the control apparatus 20 controlling the plant. The “provision” of data is provision of data from the transmission side for the reception side in contrast to “acquisition” described above, and the transmission of data may be a push type or a pull type. Thus, the first provider 102 may actively transmit second data to the control apparatus 20 or passively transmit second data through a request or the like, or the control apparatus 20 may independently download second data from the first provider 102. The first provider 102 may directly provide the acquired second data for the control apparatus 20. For example, in a case in which the first provider 102 is realized by hardware as a circuit or a conducting wire for electric conduction, the direct provision includes a case of conducting a current including second data. The direct provision includes a case in which second data is stored in a temporary storage device and provided.

The acquisition requester 103 transmits an acquisition request for requesting the acquisition of device data to field devices such as the sensor device 41 and the actuator device 42. The device data represents data that can be acquired from a field device. The device data includes at least one of first data and second data. The first data, for example, is measurement data, auxiliary sensor data measured by an auxiliary sensor to be described later, or the like. The second data is, for example, calculation data, diagnosis data generated by a diagnoser to be described later, or the like.

The acquisition requester 103 asynchronously transmits an acquisition request with a predetermined period, in which the second data is output from a field device. “Asynchronously” means “not synchronized.” The acquisition requester 103 may transmit an acquisition request at an arbitrary timing to a field device. Thus, the acquisition requester 103 may transmit an acquisition request in synchronization with the predetermined period described above. In a case in which the second data acquirer 101 acquires the second data that is periodically transmitted from the sensor device 41, the acquisition requester 103 may request acquisition of the first data or the second data of a different type at a timing different from that of the acquisition of the second data. In this way, even in the case of a communication system in which two pieces of data cannot be simultaneously transmitted, a plurality of types of data can be acquired.

For example, there are cases in which the sensor device 41 cannot simultaneously transmit both the second data and the first data but can transmit only one of the second data, the first data, and the like in accordance with the communication standard of the field communication. The acquisition requester 103 may transmit a transmission request to a field device at an unoccupied time in the transmission period of the second data. The field device can store a parameter used for determining the operation of the field device therein. The acquisition request may include, for example, a parameter used for changing data transmitted by a field device to first data and the like and the second data and a command used for setting a transmission timing at which the first data and the like are transmitted, a transmission period, a transmission time, the number of transmissions, and the like. A transmission period of the second data, for example, may be used for designating a period such as one second. The transmission period of the first data and the like may be set such that the transmission of the second data is prioritized. For example, in a case in which the transmission period of the first data and the like is set to one minute, a period except for the transmission period of the second data in one minute may be set as a substantial transmission period of the first data and the like. The acquisition request may include a command used for returning a parameter of the sensor device 41, which has been used for temporarily changing the setting of the operation relating to the transmission of the first data and the like and the second data, to its original value.

The acquisition requester 103 may request acquisition of the second data instead of the acquisition of the first data and the like. For example, in a case in which a trend of measurement data measured by the sensor device 41 is to be analyzed, calculation data in which noise of the measurement data may be eliminated. The acquisition requester 103 may include a command for requesting acquisition of the second data or the first data and the like or acquisition of both the second data and the first data and the like in an acquisition request.

The first data acquirer 104 acquires the first data and the like according to the acquisition request transmitted by the acquisition requester 103 from a device. The first data acquirer 104, for example, may acquire one piece of the first data and the like for one acquisition request. The first data acquirer 104, for example, may acquire a plurality of pieces of first data and the like for one acquisition request. The “acquisition” operation of the first data is similar to the acquisition operation of the second data acquirer 101 regardless of the direction of transmission/reception.

The storage 105 stores the first data and the like acquired by the first data acquirer 104. The storage 105, for example, stores the first data and the like in a storage device, which is not shown in the drawing, disposed inside the device information providing apparatus 10. The storage 105 may store the first data in a storage device such as a data server, which is not shown in the drawing, disposed outside the device information providing apparatus 10. In other words, the storage 105 may store a stored place of the first data and the like instead of the first data and the like. The storage 105 may store the first data and the like with information of parameter data and the like such as acquisition date and time, recording date and time, a tag name of a field device, and the like added thereto.

The use request acquirer 106 acquires a use request based on an application programming interface (API) used for using the first data stored in the storage 105 through a network 94. The application programming interface (API) is a standard of an interface used by a software component for exchange of data. The API according to one or more embodiments enables the functions provided by the device information providing apparatus 10 to be used by a utilization device 50 (50A, 50B, and the like) that is an external apparatus. In the API, specifications such as a subroutine of a program, a data structure, an object class, and variables may be included. By performing programming based on the API in an operation program used for operating the utilization device 50, the utilization device 50 can easily use the functions provided by the device information providing apparatus 10. The API, for example, can be provided for a developer of a program of the utilization device 50 using a document or a library.

In the API, for example, arguments used for designating conditions for extracting device data such as a specific sensor device 41, a type of device data (calculation data, measurement data, auxiliary sensor data, diagnosis data, or the like), a range of recording date and time of the first data from among the device data stored in the device information providing apparatus 10 may be configured to be definable. In the API, an argument used for designating a process to be performed by the device information providing apparatus 10 such as processing including sorting, statistical processing, and the like of device data may be configured to be definable. By using the API, device data according to various use purposes can be provided.

The second provider 107 provides device information based on the device data stored in accordance with a use request acquired by the use request acquirer 106 for the utilization device 50 through the network 94. The “device information” based on the device data is stored in the storage 105 and is provided in accordance with a use request from the utilization device 50 (having “App” to be described later). The device information is provided for the utilization device 50 through the API. The device information, for example, includes information acquired by sorting the first data described above, information acquired by adding certain data to the first data, information acquired by processing the first data, or the like. The “device information,” may include the device data as it is. In other words, the device information according to one or more embodiments may include all the information based on the device data.

The second provider 107 may provide information based on the second data. For example, the storage 105 may further store the second data in addition to the first data, and the second provider 107 may provide at least one of the first data and the second data stored in the storage 105 in accordance with a use request. In this way, device data, which includes the second data, according to various use purposes can be provided.

At least one or more functions among the functions of the device information providing apparatus 10 may be realized by hardware.

Any one of the functions of the device information providing apparatus 10 may be divided into a plurality of functions to be executed. The device information providing apparatus 10 may integrate any two or more functions described above into one function to be executed.

The device information providing apparatus 10 may be an apparatus realized using one casing or a system realized by a plurality of apparatuses connected through a network or the like. For example, the device information providing apparatus 10 may be a virtual apparatus such as a cloud service provided using a cloud computing system. A cloud computing system, for example, is a system configured to provide one or a plurality of services and hardware and software resources shared by a plurality of devices, nodes, servers, and the like in accordance with use from one or a plurality of clients. The device information providing apparatus 10 may be a general-purpose computer such as a server apparatus or a dedicated apparatus of which the function is limited.

At least one or more functions among the above-described functions of the device information providing apparatus 10 may be realized by another apparatus. In other words, the device information providing apparatus 10 does not need to have all the functions described above but may have some of the functions.

The control apparatus 20 controls the plant on the basis of the second data. The control apparatus 20, for example, is a DCS control apparatus, a programmable logic controller (PLC), or the like. The control apparatus 20, for example, drives the actuator device 42 on the basis of the second data. The control apparatus 20 is operated by a control program that controls the control apparatus 20. The control apparatus 20 is connected to the device information providing apparatus 10 through a network 92, acquires the second data of the sensor device 41 connected to the network 91 through the device information providing apparatus 10, and drives the actuator device 42. In other words, FIG. 1 shows a case in which the device information providing apparatus 10 relays communication between the control apparatus 20 and the field device.

As described above, the second data is acquired by performing calculation for eliminating noise included in measurement data measured by the sensor device 41 or the like and the like. There are cases in which noise gives an instantaneous abnormal value to measurement data. When control based on an abnormal value is performed, the stability of the plant decreases, and there are cases in which there is an influence on the product quality in the plant. By using the second data from which noise has been eliminated, the control apparatus 20 can improve the stability of the plant.

By using the second data, the control apparatus 20 can reduce a process load of the control apparatus 20 and a production load of a control program. For example, in a case in which the elimination of noise included in measurement data is executed by a control program of the control apparatus 20, a calculation process corresponding to a type and characteristics of the sensor device 41 is necessary on the control apparatus 20 side. For example, in a case in which the control apparatus 20 is a PLC or the like of which CPU power is not large, it is difficult for a control program of the PLC or the like to execute noise elimination corresponding to each sensor device 41 due to the process load of the PLC or the like. In a case in which a plurality of control apparatuses 20 operate in a plant in which many sensor devices 41 are installed, it is necessary to produce a control program executing a calculation process that is appropriate for each of the sensor devices 41 for each of the control apparatuses 20. By using the second data for which a calculation process that is appropriate for each of the sensor devices 41 has been performed by each of the sensor devices 41, the control apparatus 20 can reduce the production load of a control program.

The data server 31 (31A, 31B, and the like) acquires and stores operation information relating to the operating of the plant from the control apparatus 20 through a network 93. The operation information, for example, includes the second data acquired by the control apparatus 20, drive data (control data), which is generated by the control apparatus 20, used for driving the actuator device 42, and the like. The drive information may include quality information of products produced in the plant, quantity information of manufactured products, information of an operating company, and the like.

The data server 31 may acquire and store operation records, malfunction records, and maintenance records of field devices or apparatuses disposed in the plant, diagnosis data of the sensor device 41 or the actuator device 42, event information of alarms and alerts, and the like.

The data server 31, for example, is a web server, an OPC server, an alarm and event server, or the like. The web server provides a display screen of hypertext markup language (HTML) or the like for a web browser using a hypertext transfer protocol (HTTP). The OPC server is a server in which an interface standardized by OPC Foundation is mounted. The data server 31 may be a core business system of a company that operates the plant. The core business system, for example, is an enterprise resource planning (ERP) system dedicated for a process manufacturing business. In the ERP system, operation information and device information can be collected as management information.

The operation monitoring apparatus 32 is used for monitoring operation information stored in the data server 31. The operation monitoring apparatus 32, for example, enables operation monitoring staff to check the operation status of the plant by displaying the operation information of the plant on a display device. The operation monitoring staff, for example, changes setting values of a field device or transmits an instruction value to an actuator device on the basis of the operation status of the plant.

The device monitoring apparatus 33 monitors, for example, information of a plant such as diagnosis data, an alarm, a setting parameter for a device, the status of a device, and the like stored in the data server 31. The device monitoring apparatus 33, for example, enables device monitoring staff to check a device state by displaying the information of the plant on a display device. The device monitoring staff, for example, performs or instructs a maintenance operation such as replacement or the like of the sensor device 41 or the actuator device 42 on the basis of the information of the plant.

The utilization device 50 (50A, 50B, or the like) uses the functions provided by the device information providing apparatus 10 by executing an application program (hereinafter, abbreviated to “App”) using the API of the device information providing apparatus 10. The App, for example, executes a process of analyzing measurement data. The App of the utilization device 50 transmits a use request based on the API to the use request acquirer 106 of the device information providing apparatus 10 and acquires device information according to the use request from the second provider 107.

By performing communication with the control apparatus 20, the utilization device 50, for example, transmits a control direction to the control apparatus 20 (20B) on the basis of a result of the process in the App of the utilization device 50. The App of the utilization device 50 may acquire a result of the process of the control apparatus 20 and use the result for a process of analysis or the like.

FIG. 1 shows the case of an example in which the sensor device 41 or the actuator device 42 and the device information providing apparatus 10 communicate with each other through the network 91, the device information providing apparatus 10 and the control apparatus 20 communicate with each other through the network 92, the control apparatus 20 and the data server 31, the operation monitoring apparatus 32, or the device monitoring apparatus 33 communicate with each other through the network 93, and the device information providing apparatus 10 and the utilization device 50 communicate with each other through the network 94. The types of the networks 91 to 94 are arbitrary, and any two or more networks among the networks 91 to 94 may be configured as the same network. For example, the network 91 and the network 92 may be configured as networks using field communication, and the network 93 and the network 94 may be configured as networks using communication that uses a communication protocol such as TCP/IP.

### [Hardware Configuration of Device Information Providing Apparatus]

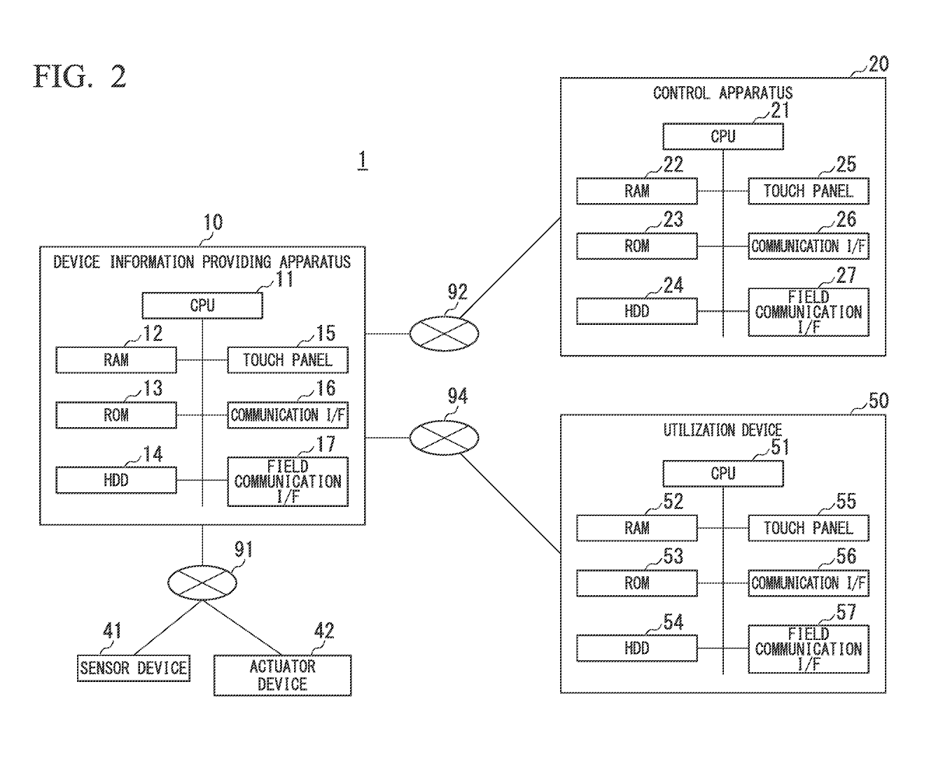

FIG. 2 is a diagram showing one example of the hardware configuration of the device information providing apparatus according to one or more embodiments.

As shown in FIG. 2, the device information providing apparatus 10 includes a central processing unit (CPU) 11, a random access memory (RAM) 12, a read only memory (ROM) 13, a hard disk drive (HDD) 14, a touch panel 15, a communication interface (I/F) 16, and a field communication I/F 17. Such a configuration is one example of the hardware configuration of the device information providing apparatus 10 and does not show an essential configuration. For example, a touch panel 15 is one of additional components of the device information providing apparatus 10. In the case shown in FIG. 2, the control apparatus 20 and the utilization device 50 will be described to have the same hardware configurations as those of the device information providing apparatus 10. Description of hardware having the same function may be omitted.

The device information providing apparatus 10 executes the device information providing program described with reference to FIG. 1. As described above, the device information providing apparatus 10 may be either a general-purpose computer such as a server apparatus or a dedicated apparatus of which functions are limited. The device information providing apparatus 10 may commonly use the hardware with the control apparatus 20. For example, in a case in which the control apparatus 20 is a computer such as a PLC or the like, the device information providing apparatus 10 may be implemented in an I/O module of a communication I/F 26 or the like of the PLC or the like, and the device information providing apparatus 10 may be implemented by sharing hardware in the same casing as that of the field device. Variations in the mounting thereof will be described later.

The CPU 11 performs control of the device information providing apparatus 10 by executing a device information providing program stored in the RAM 12, the ROM 13, or the HDD 14. The device information providing program, for example, is acquired from a storage medium on which the device information providing program is stored, a server providing the device information providing program through a network, or the like, is installed in the HDD 14, and is stored in the RAM 12 to be readable from the CPU 11.

The touch panel 15 has an operation/display function having an operation input function and a display function. The touch panel 15 displays a user interface (UI) of a program executed by the device information providing apparatus 10. The touch panel 15 enables a user to perform an operation input using a fingertip, a touch pen, or the like. Although a case in which the device information providing apparatus 10 according to one or more embodiments uses the touch panel 15 having the operation/display function is described, the device information providing apparatus 10 may include a display device having a display function and an operation input device having an operation input function. In such a case, a display screen of the touch panel 15 is a display screen of the display device, and an operation for the touch panel 15 can be performed as an operation for the operation input device. The touch panel 15 may be realized using various forms such as a head-mount type display, a glass type display, and a wrist-watch type display.

The communication I/F 16 controls communication with other apparatuses using general communication such as wireless LAN communication, wired LAN communication, infrared communication, or near field communication through the network 94. For example, the other apparatuses are a cloud server that is not shown in the drawing, an apparatus in which an external application is arranged, and the like in addition to the control apparatus 20 and the utilization device 50. The cloud server is a server that provides a cloud service using cloud computing. The cloud server, for example, may temporarily store big data including device data and the like. The cloud server may provide information that is common to the device information providing apparatus 10 for another device information providing apparatus not shown in the drawing. The external application is an application operating outside the device information providing apparatus 10 and, for example, may be a part of the function of the device information providing apparatus 10 described with reference to FIG. 1. The communication I/F 16 may communicate with another device information providing apparatus, a field device capable of performing general communication, a maintenance information management server managing maintenance information, a DCS control apparatus, a PLC, and the like that are not shown in the drawing. The external application may be present on a storage medium that can be read from the device information providing apparatus 10 or inside the device information providing apparatus 10.

The field communication I/F 17 controls field communication with a field device through the network 91 using a communication protocol that can be used by the field device. In various field devices used in the plant, various field communication protocols are used. The field communication I/F 17, for example, controls communication with field devices using field communications of ISA100 (registered trademark), HART (registered trademark), BRAIN (registered trademark), FOUNDATION Fieldbus, PROFIBUS, and the like. The device information providing apparatus 10 may include a plurality of field communication I/Fs 17 in accordance with the types of field communication.

[Data Transmission to and Reception from Sensor Device]

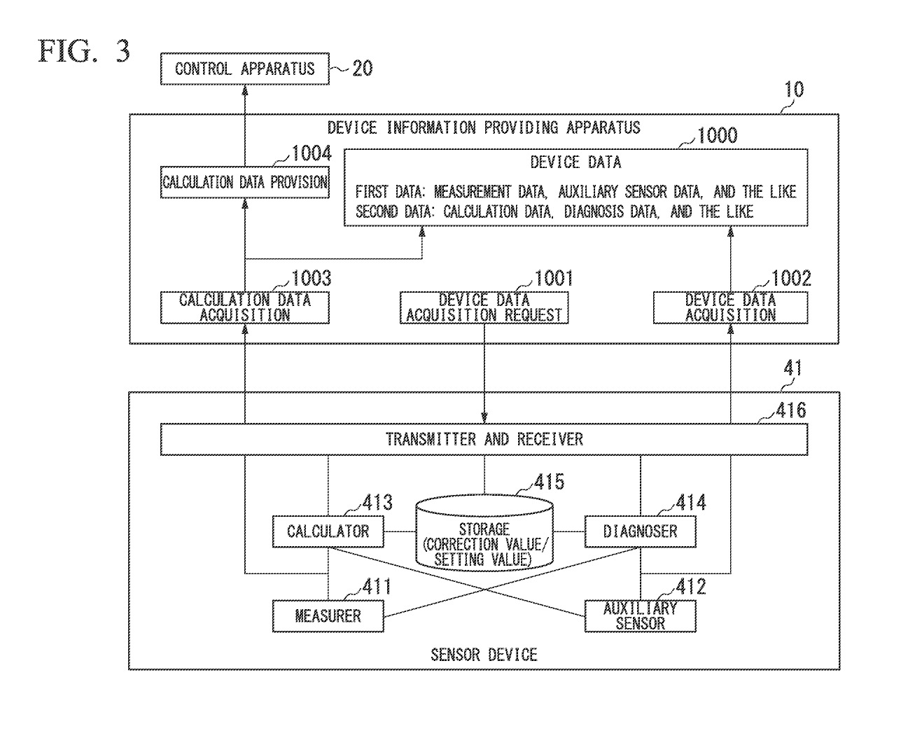

FIG. 3 is a diagram showing one example of data transmission and reception between the device information providing apparatus according to one or more embodiments and a sensor device.

As shown in FIG. 3, the device information providing apparatus 10 has functions of a device data storing unit 1000, a device data acquisition request 1001, a device data acquisition 1002, a calculation data acquisition 1003, and a calculation data provision 1004. The sensor device 41 has functions of a measurer 411, an auxiliary sensor 412, a calculator 413, a diagnoser 414, a storage 415, and a transmitter and receiver 416. The functions of the device information providing apparatus 10 shown in FIG. 3 describe some of the functions described with reference to FIG. 1.

The measurer 411 measures (detects) measurement data (first data) measured by the sensor device 41. The measurer, for example, is a sensor that converts a physical quantity such as a pressure, a temperature, a flow rate, or a water level of a fluid including a gas, a liquid, or the like handled inside the plant into an electric signal. The measurement data measured by the measurer 411 is output to the transmitter and receiver 416 and the calculator 413. The calculator 413 performs a calculation process such as a noise elimination process for the measurement data output from the measurer 411 and outputs calculated data (the second data) to the transmitter and receiver 416. For example, there are cases in which the measurement data output to the transmitter and receiver 416 not through the calculation performed by the calculator 413 includes abnormality data representing an abnormality in the plant. The “abnormality” of the abnormality data included in the measurement data represents a state different from a steady state. For example, in process control, it is determined that the measurement data is “normal” when the measurement data is within a predetermined normal range. However, even when the measurement data is within the normal range, for example, there are cases in which data representing a sign of a malfunction of a field device or the like, which is not included in a steady state, is included. In other words, the abnormality data according to one or more embodiments is data that does not represent whether or not the measurement data is normal or abnormal but is not steady which is included even in a case in which the measurement data is within the normal range. The sensor device 41 enables the measurement data to be transmitted from the transmitter and receiver 416 together with the calculation data used for general plant control.

The auxiliary sensor 412 is a sensor that supports measurement performed by the measurer 411. The auxiliary sensor 412 generates measurement data (auxiliary sensor data) such as correction data for the measurement data measured by the measurer 411. The generated auxiliary sensor data is output to the transmitter and receiver 416 and also output to the calculator 413. For example, in a case in which the measurement data is a measured pressure, the auxiliary sensor 412 measures a temperature and generates temperature data to enable the calculator 413 to make a temperature correction for pressure data. Since the auxiliary sensor 412 is a sensor that generates measurement data, there are cases in which the auxiliary sensor data generated by the auxiliary sensor 412, similar to the measurement data output from the measurer 411, includes abnormality data representing an abnormality in the plant. The sensor device 41 enables the auxiliary sensor data measured by the auxiliary sensor 412 to be transmitted from the transmitter and receiver 416 as a part of the first data.

The diagnoser 414 diagnoses the operation state of the sensor device 41 on the basis of the measurement data acquired by the measurer 411 and the auxiliary sensor data acquired by the auxiliary sensor 412. A result of the diagnosis acquired by the diagnoser 414 can be output from the transmitter and receiver 416 as diagnosis data (second data). The storage 415 stores parameters such as a correction value of measurement data, a setting value of the sensor device 41, and the like. The parameters, for example, may be various parameters determined in communication standards of the field communication. The parameters may include, in addition to the correction value of the measurement data, for example, identification information used for identifying the sensor device 41 and tag information.

The transmitter and receiver 416 transmits data to the device information providing apparatus 10 and receives data from the device information providing apparatus 10. The transmitter and receiver 416 may temporarily store the measurement data, the auxiliary sensor data, the calculation data, or the diagnosis data and provide the stored data for the device information providing apparatus 10. The transmitter and receiver 416 transmits the calculation data to the device information providing apparatus 10 at a transmission interval set in advance, for example, a period of one second or the like. The transmitter and receiver 416 transmits device data according to an acquisition request from the device information providing apparatus 10 to the device information providing apparatus 10.

The device data acquisition request 1001 transmits an acquisition request for requesting acquisition of device data to the transmitter and receiver 416. The device data is at least one of the first data and the second data. The device data acquisition 1002 acquires device data according to the acquisition request and stores the acquired device data in the device data storing unit 1000. The first data, for example, is measurement data, auxiliary sensor data, or the like. The second data, for example, is calculation data, diagnosis data, or the like.

The calculation data acquisition 1003 acquires calculation data transmitted from the calculator 413. The calculation data acquired by the calculation data acquisition 1003 is provided for the control apparatus 20 through the calculation data provision 1004 and is used for process control. The calculation data acquired by the calculation data acquisition 1003 may be stored in the device data storing unit 1000.

[Data Transmission to and Reception from Actuator Device]

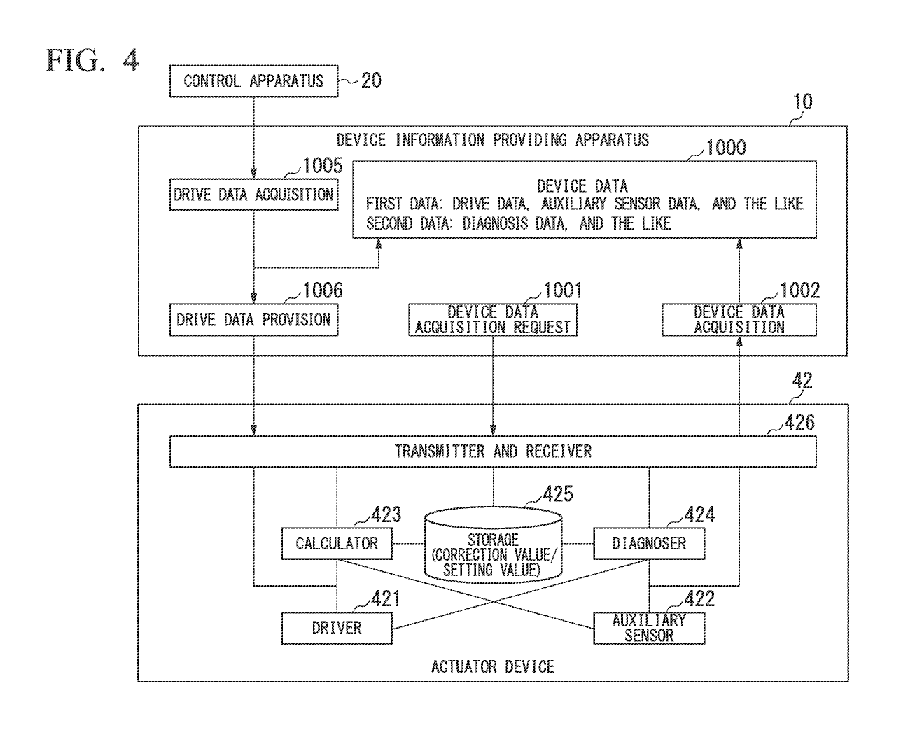

FIG. 4 is a diagram showing one example of data transmission and reception between the device information providing apparatus according to one or more embodiments and an actuator device.

As shown in FIG. 4, the device information providing apparatus 10 has functions of a device data storing unit 1000, a device data acquisition request 1001, a device data acquisition 1002, a drive data acquisition 1005, and a drive data provision 1006. The actuator device 42 has functions of a driver 421, an auxiliary sensor 422, a calculator 423, a diagnoser 424, a storage 425, and a transmitter and receiver 426. The function of the device information providing apparatus 10 shown in FIG. 4 describes some of the functions described with reference to FIG. 1.

The device data acquisition request 1001 transmits an acquisition request for requesting acquisition of device data to the transmitter and receiver 426. The device data is at least one of first data and second data. The device data acquisition 1002 acquires device data according to the acquisition request and stores the acquired device data in the device data storing unit 1000. The first data, for example, is drive data, auxiliary sensor data, or the like. The second data, for example, diagnosis data or the like. The drive data stored in the device data storing unit 1000 is first data acquired by the transmitter and receiver 426 directly reading a drive current or the like output from the calculator 423 to the driver 421. The device data storing unit 1000 may store the drive data acquired by the drive data acquisition 1005.

The drive data acquisition 1005 acquires drive data transmitted from the control apparatus 20. The drive data acquired by the drive data acquisition 1005 is control data that is provided for the transmitter and receiver 426 through the drive data provision 1006 and is used for drive control of the actuator. The drive data, for example, is control data directing the degree of opening of a valve or the like. The drive data may include control data used for controlling on and off.

The transmitter and receiver 426 performs data transmit to and data reception from the device information providing apparatus 10. The transmitter and receiver 426 may temporarily store a drive current value for driving the driver 421, auxiliary sensor data, diagnosis data, or the like and provide the stored data for the device information providing apparatus 10. When drive data provided from the drive data provision 1006 is received, the transmitter and receiver 426 transmits the drive data to the calculator 423. The transmitter and receiver 426 can directly read first data acquired from the driver 421 such as a drive current used for driving the driver 421.

The driver 421, for example, is a valve, a solenoid, a pump, or the like that is a driving target of the actuator device 42. The auxiliary sensor 422 is a sensor that supports the driving of the driver 421. For example, in a case in which the driver 421 is a valve, the auxiliary sensor 422 is an opening degree sensor detecting the degree of opening of the valve. On the other hand, in a case in which the driver 421 is a pump, the auxiliary sensor 422 is a rotation sensor detecting the rotation of the pump. The driver 421 is driven on the basis of the calculation data calculated by the calculator 423. The auxiliary sensor data detected by the auxiliary sensor 422 is output to the diagnoser 424 and the transmitter and receiver 426 together with output to the calculator 423.

The calculator 423 calculates drive data for the driver 421. The calculator 423 converts drive data, for example, of 4 to 20 mA into a voltage value directing the degree of opening of a bubble or an on/off signal of electric power. The calculator 423 may control the driving of the driver 421 using a detection result acquired by the auxiliary sensor data as feedback data.

Since the auxiliary sensor 422 is a sensor that generates measurement data, there are cases in which the auxiliary sensor data generated by the auxiliary sensor 422 includes abnormality data representing an abnormality in the plant. For example, for the diagnosis of the actuator device 42, a dedicated diagnosis device using a vibrometer, a surface thermometer, a sound level meter, or the like is used. Such a diagnosis device is high-priced, and thus, the diagnosis of the actuator, for example, is frequently performed using a handy-type diagnosis device at a regular maintenance and inspection. By using the auxiliary sensor data measured by the auxiliary sensor 422 of the actuator device 42 for analysis of abnormality detection, labor-saving and cost-down of the maintenance and inspection can be achieved.

The diagnoser 424 diagnoses the operation state of the actuator device 42 on the basis of the drive data of the driver 421 and the auxiliary sensor data of the auxiliary sensor 422. A result of the diagnosis acquired by the diagnoser 424 can be output from the transmitter and receiver 426 as second data. The storage 425 stores parameters such as a correction value of drive data, a setting value of the actuator device 42, and the like. The parameters, for example, are various parameters determined in communication standards of the field communication.

[Data Transmission to and Data Reception from Utilization Device]

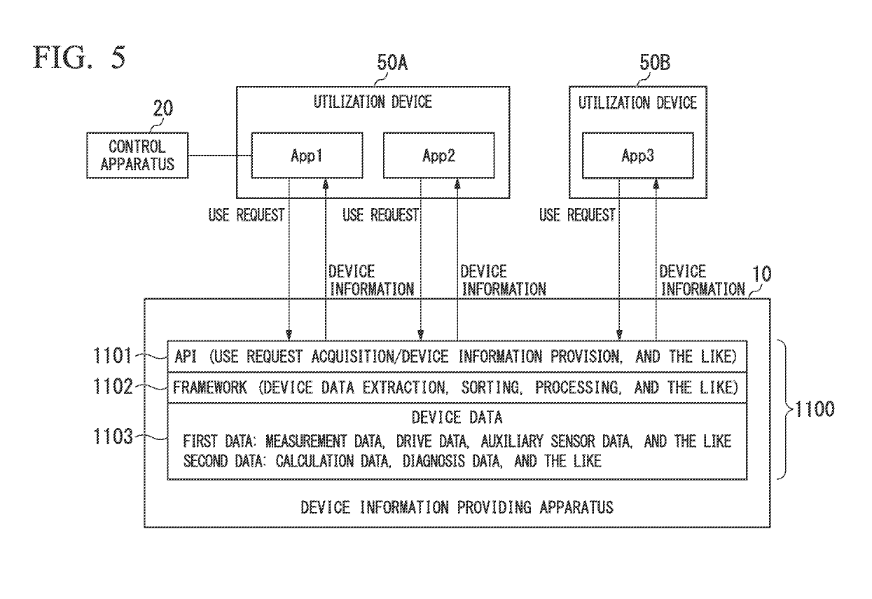

FIG. 5 is a diagram showing one example of data transmission and reception between the device information providing apparatus according to one or more embodiments and the utilization device.

As shown in FIG. 5, the device information providing apparatus 10 has functions of an API 1101, a framework 1102, and a device data storing unit 1103. The API 1101, the framework 1102, and the device data storing unit 1103 function as a platform 1100 for providing device information. The functions of the device information providing apparatus 10 described with reference to FIG. 5 describe some of the functions described with reference to FIG. 1.

The device information providing apparatus 10 is communicably connected to a plurality of utilization devices 50 such as a utilization device 50A, a utilization device 50B, and the like. The utilization device 50 can mount a plurality of Apps. For example, FIG. 5 shows that two Apps including App1 and App2 are mounted in the utilization device 50A. App3 is mounted in the utilization device 50B. App1 to App3 are programs using device data provided by the device information providing apparatus 10 and are detection programs used for detecting various types of abnormalities, for example, including an abnormality of a fluid body such as cavitation or a pulsating flow generated in the fluid body, occurrence of slurry-noise according to mixture of a foreign material, pipe clogging, and the like. App1 directly acquires or provides data from the control apparatus 20. For example, by acquiring alarm information from the control apparatus 20 and starting analysis of an abnormality and transmitting a result of the analysis to the control apparatus 20, App1 can support the control of the plant performed by the control apparatus 20.

Each App transmits a use request to the API 1101 using a data structure, an object class, or a variable defined in the API 1101. Each App acquires device information corresponding to the transmitted use request from the API 1101. In the use request, for example, information such as information specifying a field device, a type of data to be acquired, and a range of data may be included.

The API 1101 is an interface that enables the functions of the device information providing apparatus 10 to be used from the App of the utilization device 50. The API, for example, can be mounted in a subroutine of a device information providing program operating in the device information providing apparatus 10. The API 1101 acquires a use request from the utilization device 50 and provides device information corresponding thereto. In the API 1101, conditions for extracting device data such as a specific sensor device 41, a type of device data (calculation data, measurement data, auxiliary sensor data, diagnosis data, or the like), a range of recording date and time of device data from among the device data stored by the device information providing apparatus 10 may be configured to be definable. In the API, an argument used for designating a process to be performed by the device information providing apparatus 10 such as sorting, processing including statistical processing, and the like of device data may be configured to be definable. The API 1101 may provide a function of directing acquisition of data other than the device information or setting of a parameter for a field device. The data other than the device information, for example, is data used for checking the operation state of the device information providing apparatus 10, data representing a type and a range of device information that is stored in the device information providing apparatus 10 and can be acquired, data used for checking a version and the like of the API, and the like. By using the API 1101, the functions provided by the device information providing apparatus 10 can be easily used.

The framework 1102 is a program that realizes a function requested for the API 1101. The framework 1102, for example, executes processes of extraction of designated device data of an acquisition range, sorting of device data, simplified processing of device data, and the like. The device data storing unit 1103 stores first data or second data and the like to be usable from the framework 1102.

The platform 1100 according to one or more embodiments, which is used for providing device information, allows device data included in the device information providing apparatus 10 to be commonly usable from various Apps through the API. Here, such functions as described above may be mounted in a plurality of distributed computers, or some or all of the functions may be mounted using hardware. In generating an APP, by using the common platform 1100, for example, reuse and the like of a program can be performed, and a program generation cost can be reduced. The platform 1100 used for providing device information is one example in which the functions of the use request acquirer and the second provider shown in FIG. 1 are realized together in a layer of the platform. In other words, the configuration of the platform shown in FIG. 5 is not limited to this, and, for example, a platform 1100 of the sensor device 41 for the use of device data and a platform 1100 of the actuator device 42 for the use of device data may be realized in a divisional manner.

### [Second Data Acquiring Operation]

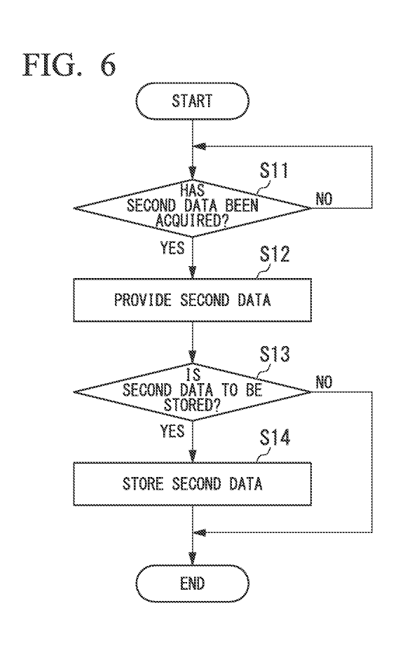

FIG. 6 is a flowchart showing one example of a second data acquiring operation of the device information providing apparatus 10 according to one or more embodiments. FIG. 6 shows an operation of acquiring second data that is transmitted at a constant period.

As shown in FIG. 6, the device information providing apparatus 10 determines whether or not the second data has been acquired (Step S11). For example, whether or not the second data has been acquired can be determined on the basis of whether or not the second data acquirer 101 has acquired calculation data periodically transmitted from the sensor device 41 or the like. In a case in which it is determined that the second data has not been acquired (Step S11: No), the device information providing apparatus 10 repeats the process of Step S11 until the second data is acquired.

On the other hand, in a case in which it is determined that the second data has been acquired (Step S11: Yes), the device information providing apparatus 10 provides the acquired second data for the control apparatus 20. For example, the first provider 102 can provide the second data for the control apparatus 20.

After the process of Step S12 is executed, the device information providing apparatus 10 determines whether the second data is stored or not (Step S13). For example, whether the second data is stored or not can be determined by performing setting of whether the acquired second data is stored in the storage 105 or not for the second data acquirer 101 in advance. In a case in which it is determined that the second data is stored (Step S13: Yes), the device information providing apparatus 10 stores the second data in the storage 105 (Step S14). The second data is used by the control apparatus 20 for process control. By storing the second data in the storage 105, the second data can be used from the utilization device 50.

After the process of Step S14 is executed, or in a case in which it is determined that the second data is not stored (Step S13: No), the device information providing apparatus 10 ends the operation shown in the flowchart. Since the operations shown in FIG. 6 are repeatedly executed, for example, instead of ending the operation, the process may be returned to the process of Step S11, and the process of Steps S11 to S14 may be repeatedly executed.

### [First Data Acquiring Operation]

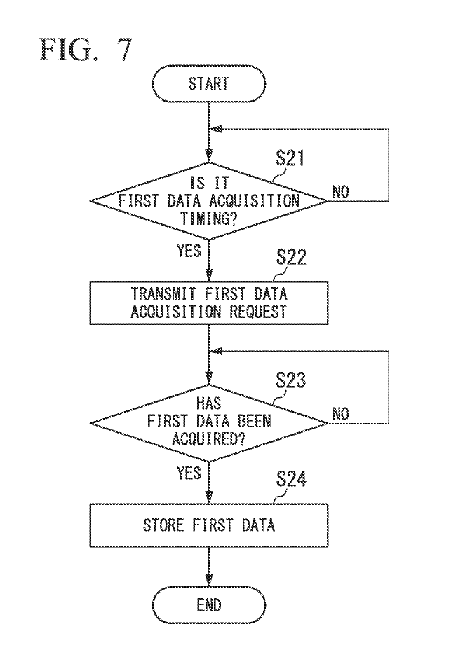

FIG. 7 is a flowchart showing one example of a first data acquiring operation of the device information providing apparatus 10 according to one or more embodiments.

As shown in FIG. 7, the device information providing apparatus 10 determines whether or not it is a timing at which the first data is acquired (Step S21). Whether or not it is a timing at which the first data is acquired can be determined on the basis of whether or not the acquisition of the first data is set in the acquisition requester 103, and it is a set timing. In a case in which it is determined that it is not a timing at which the first data is acquired (Step S21: No), the device information providing apparatus 10 repeats the process of Step S21 and waits for a first data acquisition timing.

On the other hand, in a case in which it is determined that it is a timing at which the first data is acquired (Step S21: Yes), the device information providing apparatus 10 transmits a first data acquiring request (Step S22). The transmission of the first data acquiring request, for example, can be executed by the acquisition requester 103 transmitting an acquisition request to the sensor device 41 and the like.

After the process of Step S22 is executed, the device information providing apparatus 10 determines whether or not the first data has been acquired (Step S23). For example, the determination of whether or not the first data has been acquired can be determined on the basis of whether or not the first data acquirer 104 has acquired the first data. In a case in which it is determined that the first data has not been acquired (Step S23: No), the device information providing apparatus 10 repeats the process of Step S23 until the first data is acquired. On the other hand, in a case in which it is determined that the first data has been acquired (Step S23: Yes), the device information providing apparatus 10 stores the acquired first data in the storage 105 (Step S24). After the process of Step S24 is executed, the device information providing apparatus 10 ends the operation shown in the flowchart. Also the operation shown in FIG. 7 is repeatedly executed, and accordingly, for example, instead of ending the operation, the process may be returned to the process of Step S21, and the process of Step S21 to S24 may be repeatedly executed.

### [Device Information Providing Operation]

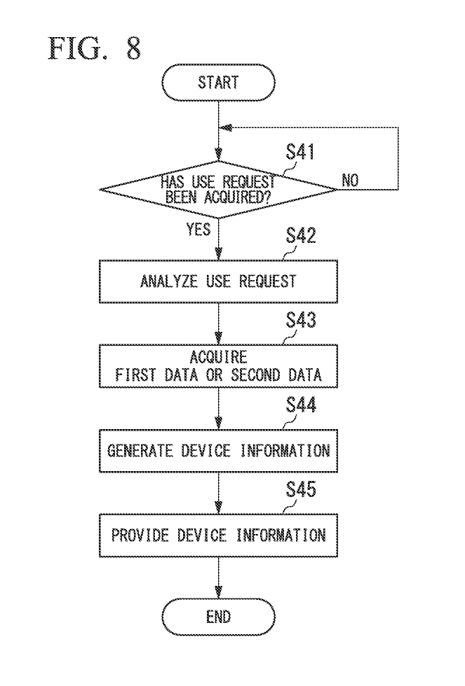

FIG. 8 is a flowchart showing one example of a device information providing operation of the device information providing apparatus 10 according to one or more embodiments.

As shown in FIG. 8, the device information providing apparatus 10 determines whether or not a use request has been acquired (Step S41). For example, whether or not a use request has been acquired can be determined on the basis of whether or not the use request acquirer 106 has acquired a use request transmitted from the utilization device 50. In a case in which it is determined that a use request has not been acquired (Step S41: No), the device information providing apparatus 10 repeats the process of Step S41 until the use request is acquired.

On the other hand, in a case in which it is determined that a use request has been acquired (Step S41: Yes), the device information providing apparatus 10 analyzes the acquired use request (Step S42). For example, the analysis of the use request can be executed by analyzing variables and the like included in the API acquired by the use request acquirer 106.

After the process of Step S42 is executed, the device information providing apparatus 10 acquires at least one of the first data and the second data (Step S43). The acquisition of the first data or the second data, for example, can be executed by making the second provider acquire device data stored in the storage 105.

After the process of Step S43 is executed, the device information providing apparatus 10 generates device information (Step S44). The device information is device data processed in accordance with a use request. The device information, for example, is information acquired by arranging device data for each field device and sorting the device data in a time series. The device information may be information acquired by extracting device data of which a numerical value is within a predetermined range. The device information may be acquired by directly reading device data. The generation of device information, for example, may be performed in a layer in which device data is processed like the framework 1102.

After the process of Step S44 is executed, the device information providing apparatus 10 provides the device information for the utilization device 50 (Step S45). The provision of the device information, for example, may be executed by providing the device information in accordance with a use request using the second provider 107. After the process of Step S45 is executed, the device information providing apparatus 10 ends the operation shown in the flowchart. Since the operation shown in FIG. 8 is repeatedly executed, for example, instead of ending the operation, the process may be returned to the process of Step S41, and the process of Steps S41 to S45 may be repeatedly executed.

Although the process of Steps S41 to S45 describes a case in which one piece of device information is provided for one use request, for example, a plurality of pieces of device information may be provided for one use request. For example, in accordance with a use request acquired from one utilization device 50, multiple transmission of device information to a plurality of utilization devices may be executed.

### [Mounting Form of Device Information Providing Apparatus]

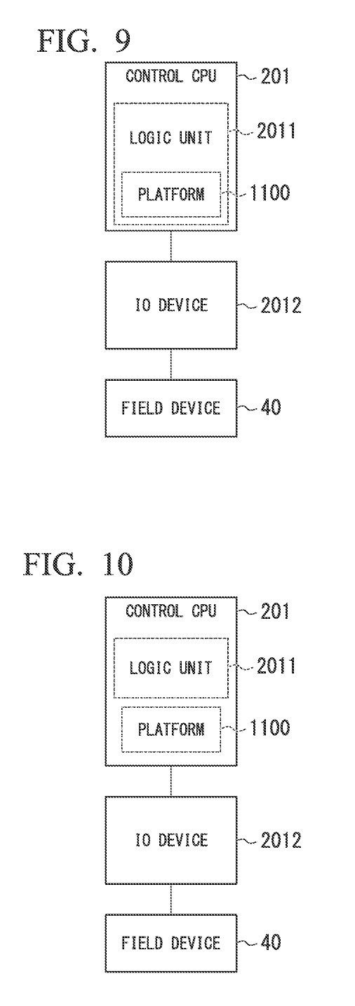

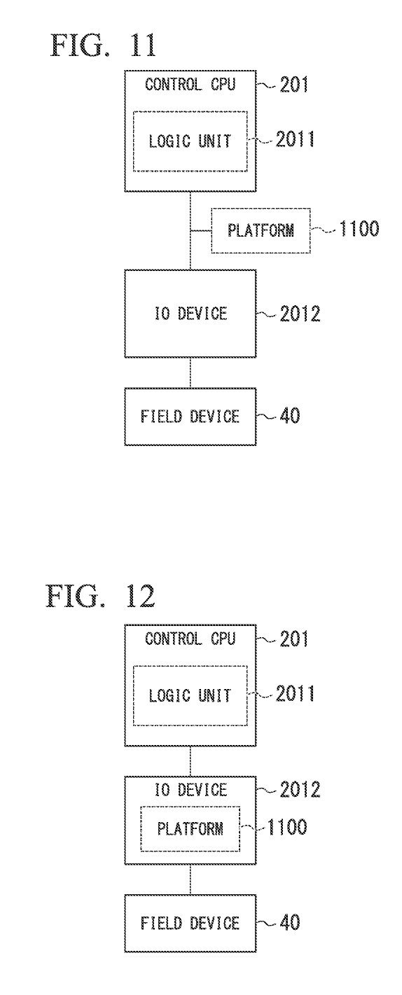

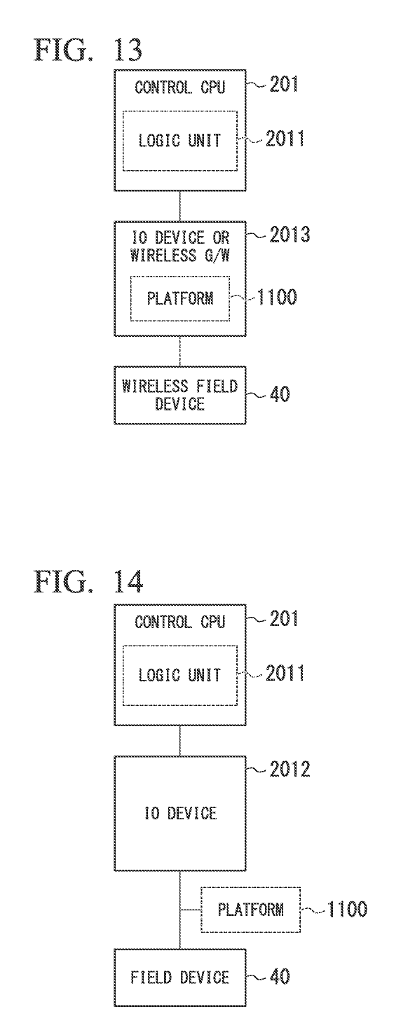

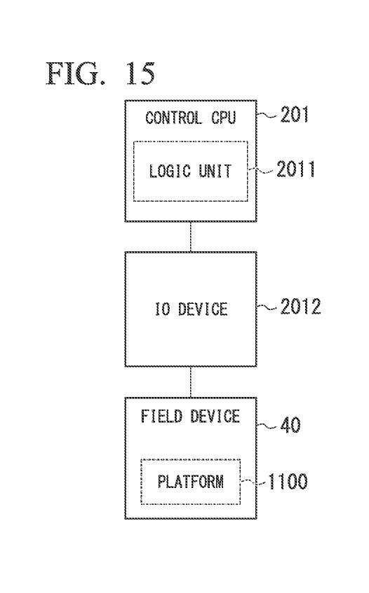

FIG. 9 is a diagram showing a first mounting form of the device information providing apparatus according to one or more embodiments. FIG. 10 is a diagram showing a second mounting form of the device information providing apparatus according to one or more embodiments. FIG. 11 is a diagram showing a third mounting form of the device information providing apparatus according to one or more embodiments. FIG. 12 is a diagram showing a fourth mounting form of the device information providing apparatus according to one or more embodiments. FIG. 13 is a diagram showing a fifth mounting form of the device information providing apparatus according to one or more embodiments. FIG. 14 is a diagram showing a sixth mounting form of the device information providing apparatus according to one or more embodiments. FIG. 15 is a diagram showing a seventh mounting form of the device information providing apparatus according to one or more embodiments.

FIGS. 9 to 15 show variations in the mounting position of the platform 1100 described with reference to FIG. 5. In other words, the device information providing apparatus 10 according to one or more embodiments may be an apparatus other than the field device or the control apparatus 20 as described with reference to FIG. 1 or 2 or one unit of the function of another apparatus.

In the case shown in FIG. 9, a platform 1100 is mounted in a logic unit 2011 of a control program of a control CPU of the control apparatus 20. In other words, the platform 1100 is mounted in the control program of the control apparatus 20. In the mounting shown in FIG. 9, the control apparatus 20 can be used, and accordingly, introduction costs can be reduced without adding a new apparatus. The mounting form shown in FIG. 9 is effective when the processing capability of the control CPU 201 is high.

In the case shown in FIG. 10, a platform 1100 is mounted as a program different from a logic unit 2011 of a control program of a control CPU of a control apparatus 20. In other words, the platform 1100 is mounted as a program operating in parallel with the control program of the control apparatus 20. In the mounting shown in FIG. 10, the control apparatus 20 can be used, and accordingly, introduction costs can be reduced without adding a new apparatus. Since the platform 1100 and the logic unit 2011 are separately mounted, the platform 1100 and the control program can be separately managed. The mounting form shown in FIG. 10 is effective when the processing capability of the control CPU 201 is high. The platform 1100 and the logic unit 2011 may be independently disposed in a virtualization unit that is disposed on the control CPU 201.

In the case shown in FIG. 11, a platform 1100 is mounted in the middle of a control apparatus 20 and an IO device 2012. The platform 1100 is disposed in a communication line between the control apparatus 20 and the IO device 2012. Accordingly, the influence of the platform 1100 on the control apparatus 20 can be decreased.

In the case shown in FIG. 12, a platform 1100 is mounted inside an IO device 2012. The IO device 2012, for example, is an IO module of a PLC. By mounting the platform 1100 inside the IO device 2012, introduction costs can be reduced without adding a new apparatus.

In the case shown in FIG. 13, a platform 1100 is mounted inside a wireless gateway (G/W) 2013. The wireless gateway 2013, for example, is a wireless G/W of a PLC. By mounting the platform 1100 inside the wireless gateway 2013, introduction costs can be reduced without adding a new apparatus.

In the case shown in FIG. 14, a platform 1100 is mounted in the middle of an IO device 2012 and a field device 40. Accordingly, even in a case in which the field device is daisy-chain connected, or the field device has multiple functions, device data can be efficiently collected.

In the case shown in FIG. 15, a platform 1100 is mounted inside a field device 40. By mounting the platform 1100 inside the field device 40, also in a case in which the field device has multiple functions, device data can be efficiently collected. The introduction costs can be reduced without adding a new apparatus.

The field device 40 may include an electric device such as a motor. The field communication may be performed in a digital mode.

As described above, according to one or more embodiments, a device information providing apparatus includes: a first provider providing second data that is acquired by performing a predetermined process for first data that is data output from a device installed in a plant and is detected inside the device for a control apparatus controlling the plant; an acquisition requester transmitting an acquisition request for acquiring the first data to the device; a storage storing the first data output from the device in accordance with the acquisition request; and a second provider providing the first data stored in the storage for the outside in accordance with a use request input from the outside. By employing such a configuration, device data of a field device can be provided as device information according to a use purpose.

In one or more embodiments, a case has been described in which the second data includes both data acquired at a fixed cycle and data acquired asynchronously from the fixed cycle. However, for example, the data acquired at the fixed cycle and the data acquired asynchronously may be differently set as second data and third data. In other words, the method of acquisition of the second data is not limited thereto.

According to one or more embodiments, a device information providing method includes providing second data that is acquired by performing a predetermined process for first data that is data output from a device installed in a plant and is detected inside the device for a control apparatus controlling the plant, transmitting an acquisition request for acquiring the first data to the device, storing the first data output from the device in accordance with the acquisition request, and providing the first data stored in the storing of the first data for the outside in accordance with a use request input from the outside. By employing such a configuration, the device data of a field device can be provided as device information according to a use purpose.

The device information providing method described above may be a method including the steps described above, and such steps may be executed in an arbitrary order. In other words, the timing of execution of each step described above is arbitrary, and, for example, after any one of the steps described above is executed several times, the other steps may be executed.

By recording a program used for realizing the functions constituting the apparatus described in one or more embodiments in a computer-readable storage medium and causing the program stored in the storage medium to be read and executed by a computer system, various processes according to one or more embodiments described above may be performed. The “computer system” described here may include an OS and hardware such as a peripheral apparatus. In a case in which a WWW system is used, the “computer system” is assumed to also include a homepage providing environment (or display environment). The “computer-readable storage medium” represents a storage device such as a writable non-volatile memory including a flexible disk, a magneto-optical disk, a ROM, and a flash memory, a portable medium such as a CD-ROM, or a hard disk or the like built into a computer system.

Furthermore, the “computer-readable storage medium” includes a medium storing a program for a fixed time such as a volatile memory (for example, a dynamic random access memory (DRAM)) disposed inside a computer system that becomes a server or a client in a case in which a program is transmitted through a network such as the internet or a communication line such as a telephone line. The program described above may be transmitted from a computer system storing this program in a storage device or the like to another computer system through a transmission medium or a transmission wave in a transmission medium. The “transmission medium” transmitting a program represents a medium having an information transmitting function such as a network including the Internet and the like or a communication line including a telephone line. The program described above may be used for realizing a part of the functions described above. The program described above may be a program realizing the functions described above by being combined with a program stored in the computer system in advance, a so-called a differential file (differential program).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A device information providing apparatus comprising:
a central processing unit (CPU) that:
transmits an acquisition request for acquiring a first data to a device installed in a plant; and
provides, to a control apparatus for controlling the plant, second data output from the device, wherein the second data is acquired by performing a predetermined process for the first data detected by the device; and
a storage that stores the first data output from the device based on the acquisition request, wherein
the CPU further provides the first data stored in the storage to outside of the device information providing apparatus based on a use request input from the outside.

2. The device information providing apparatus according to claim 1, wherein the CPU further transmits to the device the acquisition request at a timing of a predetermined period that is necessary for generating the second data inside the device.

3. The device information providing apparatus according to claim 1, wherein the CPU further transmits the acquisition request at a timing asynchronously with a predetermined period that is necessary for generating the second data inside the device.

4. The device information providing apparatus according to claim 1,
wherein the storage further stores the second data, and
wherein the CPU further provides at least one of the first data and the second data stored in the storage based on the use request.

5. The device information providing apparatus according to claim 1, wherein the CPU further receives the use request based on an application programming interface (API) for using data stored in the storage.

6. The device information providing apparatus according to claim 1, wherein the CPU further provides the second data to the control apparatus at a constant period.

7. The device information providing apparatus according to claim 6, wherein the CPU further provides the second data to the control apparatus asynchronously with the constant period.

8. The device information providing apparatus according to claim 1,
wherein the CPU further acquires the second data periodically transmitted from the device, and
wherein the CPU further transmits the acquisition request to the device at a timing different from an acquisition timing of the second data.

9. The device information providing apparatus according to claim 8, wherein the CPU further transmits to the device the acquisition request for acquiring another second data of a different type from that of the second data acquired at the timing different from an acquisition timing of the second data.

10. A device information providing apparatus comprising:
a central processing unit (CPU) that:
provides control data output from a control apparatus for controlling a plant to a device disposed in the plant; and
transmits an acquisition request for acquiring first data to the device that acquires second data by performing a predetermined process for the first data detected by the device; and
a storage that stores the first data output from the device based on the acquisition request, wherein
the CPU further provides the first data stored in the storage to outside of the device information providing apparatus based on a use request input from the outside.

11. A device information providing method comprising:
transmitting an acquisition request for acquiring first data to a device installed in a plant;
providing, to a control apparatus for controlling the plant, second data output from the device, wherein the second data is acquired by performing a predetermined process for the first data detected by the device;
storing the first data output from the device based on the acquisition request; and
providing the first data stored to outside based on a use request input from the outside.

12. The device information providing method according to claim 11, wherein the acquisition request is transmitted to the device at a timing of a predetermined period that is necessary for generating the second data inside the device.

13. The device information providing method according to claim 11, wherein the acquisition request is transmitted to the device at a timing asynchronously with a predetermined period that is necessary for generating the second data inside the device.

14. The device information providing method according to claim 11, further comprising:
storing the second data; and
providing at least one of the first data and the second data stored based on the use request.

15. The device information providing method according to claim 11, further comprising receiving the use request based on an application programming interface (API) for using data stored.

16. The device information providing method according to claim 11, wherein the second data is provided to the control apparatus at a constant period.

17. The device information providing method according to claim 16, further comprising providing the second data to the control apparatus asynchronously with the constant period.

18. The device information providing method according to claim 11, further comprising acquiring the second data periodically transmitted from the device,
wherein the acquisition request is transmitted to the device at a timing different from an acquisition timing of the second data.

19. The device information providing method according to claim 18, further comprising transmitting to the device the acquisition request for acquiring another second data of a different type from the second data periodically acquired at the timing different from the acquisition timing of the second data.

20. A non-transitory computer-readable storage medium storing a device information providing program, which when executed by a computer, causes the computer to:
transmit an acquisition request for acquiring a first data to a device installed in a plant;
provide, to a control apparatus for controlling the plant, second data output from the device, wherein the second data is acquired by performing a predetermined process for the first data detected by the device;
store the first data output from the device based on the acquisition request; and
provide the first data stored to outside based on a use request input from the outside.
